(19) United States
(12) Patent Application Publication
(10) Pub. No.: US 2025/0184699 A1
(43) Pub. Date: Jun. 5, 2025

(54) MULTI-ACCESS EDGE COMPUTING-BASED SPECIFIC RELATIVE-SPEED SERVICE

(71) Applicant: Continental Automotive Technologies GmbH, Hannover (DE)

(72) Inventors: David Gonzalez Gonzalez, Egelsbach (DE); Andreas Andrae, Frankfurt am Main (DE); Osvaldo Gonsa, Frankfurt (DE); Hueseyin Daglioglu, Frankfurt am Main (DE)

(73) Assignee: Continental Automotive Technologies GmbH, Hannover (DE)

(21) Appl. No.: 18/845,173

(22) PCT Filed: Mar. 8, 2023
(86) PCT No.: PCT/EP2023/055834

§ 371 Date: Sep. 9, 2024

(30) Foreign Application Priority Data
Mar. 10, 2022 (DE) 10 2022 202 384.6

(51) Int. Cl. H04W 4/40; H04W 4/38

(52) U.S. Cl. CPC H04W 4/40; H04W 4/38

(57) ABSTRACT

Relative-speed data is provided as a service by: collecting, by at least one multi-access edge computing device, velocity data of objects within a service spatial domain; computing, by the at least one edge computing device, relative speed data of the objects within the service spatial domain, and integrating the computed relative speed data into a centralized data map; determining, by the at least one edge computing device according to at least one V2X application, which local relative speed data are relevant to at least one user registered as subscriber to the relative speed service; and providing, by the at least one edge computing device according to the at least one V2X application, the determined local relative speed data to the at least one user equipment according to the at least one V2X application, either periodically or on demand.

### CROSS-REFERENCE TO RELATED APPLICATIONS

The present application is a National Stage Application under 35 U.S.C. § 371 of International Patent Application No. PCT/EP2023/055834 filed on Mar. 8, 2023, and claims priority from German Patent Application No. 10 2022 202 384.6 filed on Mar. 10, 2022, in the German Patent and Trademark Office, the disclosures of which are herein incorporated by reference in their entireties.

### TECHNICAL FIELD

The invention relates to a method and a system of providing a relative speed service, based on multi-access edge computing (MEC), concerning the field of Vehicle-to-Everything (V2X) communication systems.

### BACKGROUND

Vehicle-to-everything (V2X) is a communication standard for vehicles and related entities to exchange information regarding a traffic environment. V2X includes direct vehicle-to-vehicle (V2V) communication, vehicle-to-infrastructure (V2I) communication between the vehicle and infrastructure-based devices—i.e., roadside units-, vehicle-to-person (V2P) communication between vehicles and nearby people (pedestrians, cyclists), vehicle-to-network (V2N) communication between the vehicle and cloud services concerning real-time traffic/routing, and so on. Further, V2X can use any of a variety of wireless communication technologies, cellular-based or radio-based. A component or device on a vehicle, roadside unit, or other V2X entity that is used to transmit and receive V2X messages (e.g., base station belonging to one or more Mobile Network Operators) is generically referred to as a V2X device or user equipment (UE).

However, high mobility introduces Doppler Shift (DS) in the carrier frequency at receiver side, e.g., Carrier Frequency Offset (CFO). Doppler shift depends on several factors, namely the frequency shift seen at the receiver, frequency of the source, speed difference between transceiver and receiver, speed of light and angle of velocity vectors. This effect corrupts transmitted data, hence makes decoding very difficult at receiver side. Broadly speaking, Doppler shift affects reliability, range and duration/stability of wireless connections.

Doppler shift compensation is especially relevant in cases where transceiver, receiver, or both are moving, e.g., Vehicle-to-Vehicle (V2V) communications. For Doppler shift compensation, metrics reflecting either absolute or relative speed are commonly used. When both transceiver and receiver are moving (typical case of vehicular communications), relative speed indications could be particularly useful, or even necessary.

In this context, relative speed |\vec{v_{R}}| is defined as the magnitude of the difference between the velocity vectors of transceiver and receiver. For simplicity, but without loss of generality, the mentioned cases assume movement over one-dimension only (worse-case scenario). In practice, more general cases with velocity vectors in two and three dimensions may be covered.

Nevertheless, local relative-speed information is not generated within the cellular network, particularly 5G. Within 3rd Generation Partnership Project (3GPP) work is currently done to provide 5G with mechanisms (e.g., functions and protocols) to interface and interwork with external entities based on Multi-access Edge Computing (MEC). Multi-access Edge Computing (MEC), also known as Mobile Edge Computing, means some network capabilities—conventionally implemented in a core network or a cloud network (e.g., computation, storage, data transport, etc.)—are alternatively situated at the network “edge” relative to a point of attachment of a wireless communication device (referred to herein as a user equipment device) to a wireless access network. Application services available to the attached user equipment may be configured with a subscription to multi-access edge computing services to reduce end-to-end latency in a data transport network and to enable offloading of high computation loads from the core network. In this context, the mentioned application services are referred to as vehicular applications, or V2X applications. The majority of V2X applications, particularly safety function applications, such as Forward Collision Warning (FCW) or Emergency Brake Warning (EBW) have challenging latency requirements.

On the other side, it is well-known that vehicles and roadside units are equipped with systems which collect information that may be used to derive relative speed information, such as velocity vectors, location, etc. In this respect, existing techniques include radio-based (e.g., radar, Ultra-Wide-Band, UWB), lidar, ultrasonic sensors, etc. Those have been proposed to estimate, for example, Doppler shift.

However, existing techniques and proposed absolute or relative speed estimators are ego-centric, i.e., with respect to a single point of reference at a given location and a given moment of time. No existing solution focuses on estimating a complete set of maps of relative speeds of moving objects in a spatial domain of interest. Moreover, no solution focus on pairing user equipment with V2X application(s) in the way it is intended here.

Generating a complete view of relative speeds of objects in a spatial domain requires to dynamically monitor and estimate the relative speed of every single object of interest for a V2X application (such as safety application or Automated Driving application), with respect to each other. Compiling and updating in almost real time this information would imply, for example, a two-dimensional or three-dimensional data structure, e.g., a matrix of 2D or 3D vectors.

In general, this is challenging because from the perspective of a specific pair user equipment-V2X application, the following issues need to be addressed:
1. Collect and process the required data to create the previously mentioned data structure in a centralized storage or computing device,
2. Identifying the objects of interest, e.g., relevant to a given use case or scenario within a predetermined spatial domain,
3. Repeat steps 1 and 2 with a very small temporality, very short periodicity (e.g., tens of milliseconds), and
4. Make this information (fully or partially) available as a service (according to application requirements), either on-demand or periodically to a certain group of users (subscribers of the service).

The technical problem to solve is how to assist either V2X-capable user equipment or wireless network to support V2X use cases by providing specific real-time local relative speed information.

The proposed solution aims at providing specific local relative speed information to user equipment within a given local spatial domain, such as a portion of a highway or smart intersection.

This objective is achieved according to the invention by means of the technical characteristics mentioned in the independent claims.

### BRIEF SUMMARY

Invention described herein provide for local relative speed service, specific for at least one user equipment associated with at least one V2X application.

A first aspect of the invention refers to a method performed by multi-access edge-computing devices for providing relative-speed data as service in a wireless communication environment, comprising:
collecting, by at least one multi-access edge computing device, velocity data of objects within a service spatial domain of the at least one edge computing device, by velocity data meaning time-stamped velocities, headings, locations of the respective objects,
computing, by the at least one edge computing device, relative speed data of the objects within the service spatial domain, and integrating the computed relative speed data into a centralized data map,
determining, by the at least one edge computing device according to at least one V2X application from the plurality of V2X applications, which local relative speed data are relevant to at least one user registered as subscriber to the relative speed service,
providing, by the at least one edge computing device according to the at least one V2X application from the plurality of V2X applications, the determined local relative speed data to the at least one user equipment according to the at least one V2X application, either periodically or on demand.

In such aspect, receiving velocity-related data of objects moving within a service spatial domain may include collecting velocity data measured directly by sensorial means deployed within the service spatial domain of at least one multi-access edge-computing device.

Some embodiments may provide that the centralized relative-speed data map is maintained in at least one edge computing device and includes continuously updated relative-speed data of all the objects within the service spatial domain of the at least one edge-computing device.

Further embodiments may provide that determining, by the at least one edge-computing device according to at least one V2X application from the plurality of V2X applications, which local relative-speed data are relevant to at least one user registered as subscriber to the relative-speed service, comprises identifying which are the objects of interest for a situation, use case or scenario specified by the at least one V2X application, by analyzing respective objects' locations, velocities and relative-speeds in respect to each other at a given time.

Further embodiments may include that providing the determined local relative-speed data to the at least one user equipment according to the at least one V2X application, further means making the determined data available in a format suitable for the user equipment according to the at least one V2X application.

In case the user is a mobile user equipment-V2X application pair able to provide information regarding a planned route of the user towards a planned destination, another embodiment of the method further comprises receiving by at least one multi-access device the information regarding the planned route and determining which other multi-access edge computing devices are providing the service along the planned route. Alternatively, such embodiment may include providing by at least one multi-access device, information to the user regarding alternative routes with continuously provided relative speed service, until the indicated destination is reached.

Another aspect of the invention refers to a system for providing relative-speed data as a service covering a service spatial domain, comprising:
sensorial means measuring velocity data of objects within the service spatial domain, by velocity data meaning time-stamped locations, headings, velocities of the respective objects,
user equipment able to communicate wirelessly via various communications interfaces, transmitting and receiving relative speed data requested by a plurality of V2X applications, and
at least one multi-access edge computing device configured to perform operations comprising:
collecting, by at least one multi-access edge computing device, velocity data of objects within a service spatial domain of the at least one edge computing device, by velocity data meaning time-stamped velocities, headings, locations of the respective objects,
computing, by the at least one edge computing device, relative speed data of the objects within the service spatial domain, and integrating the computed relative speed data into a centralized data map,
determining, by the at least one edge computing device according to at least one V2X application from the plurality of V2X applications, which local relative speed data are relevant to at least one user registered as subscriber to the relative speed service, and
providing, by the at least one edge computing device according to the at least one V2X application from the plurality of V2X applications, the determined local relative speed data to the at least one user equipment according to the at least one V2X application, either periodically or on demand.

In such aspect, some embodiments may include sensors placed on infrastructure deployed within the service spatial domain, e.g., radar, camera, lidar, ultrasonic sensors belonging to road infrastructure. Further embodiments may include sensorial means belonging to vehicles moving within the service spatial domain and feeding the relative-speed service, including Unmanned Aerial Vehicles (UAV) or drones carrying radar, camera, lidar or ultrasonic sensors. Some further embodiments may include as user equipment a mobile device, wearable device, conventional or smart personal mobile phone, a car-mounted user equipment, and/or any user equipment embedded in mobile objects, such as drones, motorbikes, e-Bikes, delivery robots, personal mobility devices, wheelchairs, scooters.

Another aspect of the invention is related to a multi-access edge-computing device associated with a relative-speed service, comprising at least one wireless communication interface, a memory, and one or more processors communicatively coupled with the communication interface and memory and configured with processor-executable instructions to perform operations of the method.

In such aspect, some embodiments of multi-access edge-computing device include base stations, mobile network node, roadside units, roadside access points, nodes or servers with edge-computing functions, situated in geographic proximity to the relative-speed service spatial domain.

Another aspect of the invention refers to a non-transitory processor-readable medium having stored thereon processor-executable instructions configured to cause a processor of an edge-computing device to perform operations of the method.

The Multi-access computing specific Relative Speed Service according to embodiments of the invention has multiple advantages:
provides critical information to adjust transmissions at physical layer according to the mobility conditions of transceiver and receiver in V2V scenarios. This information can also be used at application level,
reduces to the minimum the information transmitted to every user equipment device as the information is selected at edge-computing level focusing on requirements of user equipment—V2X application,
the prohibitive computational burden is moved to the multi-access computing means, where generous processing power is available to concentrate and properly integrate information from different sensors. This task is not feasible for mobile devices,
introduces an enhanced interaction between different layers (application and physical), or at least an in-built cross-layer interaction for V2X, thus being of relevance for techniques beyond 5G (e.g., 6G).

A better understanding of the nature and advantages of embodiments of the present invention may be gained with reference to the following detailed description and the accompanying drawings.

### BRIEF DESCRIPTION OF DRAWINGS

FIG. 1 presents a multi-access edge computing system for providing specific local relative-speed service, according to embodiments of the invention.

FIG. 2 illustrates a flow diagram of a method of providing relative-speed data as a service RES, according to embodiments of the invention.

FIG. 3a illustrates a first use-case scenario of transmitting Cooperative Awareness messages concerning an Emergency Brake Warning, without input data from a relative-speed service.

FIG. 3b illustrates a second use-case scenario of transmitting Cooperative Awareness messages concerning the Emergency Brake Warning with input data from a relative-speed service.

FIG. 4 illustrates an embodiment of relative-speed service (RES) in a service domain covering an intersection, and providing specific relative-speed data to an Emergency Brake Warning V2X application.

FIG. 5 illustrates the case in FIG. 3 as seen in a virtual domain.

FIG. 6 illustrates another use case for providing a relative speed service to two users with different communication ranges.

FIG. 7 presents a centralized data map comprising relative speed data of several users of the service RES.

### DETAILED DESCRIPTION

The advantageous concept and other embodiments are described in detail below.

As referred to herein, “user equipment” refer to devices capable of transmitting and receiving V2X messages. The generic term of “objects” referred to herein includes vehicles or non-vehicles detected by sensors, as described in the embodiments herein, and refers to detected vehicles, non-vehicles or people (pedestrians, cyclists, personal mobility devices, delivery robots, etc.), which may be on or near the road.

In V2X communication, data transmitted by one user equipment may be received by another user equipment only within a certain distance of the transmitting user equipment (the so-called “relevant communication distance” or “communication range”). Even so, there are cases when, due to Doppler shift, it is not possible to decode properly the received data (packed as a message, for example a Cooperative Awareness message CAM) even though the receiver is within the communication range. Moreover, vehicles attempting to traverse an intersection may only find data relevant within a certain proximity to the intersection, or vehicles participating to cooperative driving may find data relevant only if they are affected by a maneuver such as emergency braking, for example. Hence, the need to address local data, of relevance for a given local spatial domain, a locality or an area understood in geographical terms, but having fluid boundaries given by the technological performance of the multi-access edge devices, networks and user equipment involved.

Stationary or mobile units may be deployed at intersections or along roads within a service spatial domain to collect velocity data of objects (vehicles or non-vehicles such as pedestrians, cyclists, personal mobility devices, delivery robots, etc., which may be on or near the road) measured through various sensorial means. Edge-computing devices (e.g., local base stations with edge computing functions) associated with the service spatial domain (i.e., situated in geographic proximity to the service spatial domain) may receive the collected data via multi-access communication interfaces (i.e., by local radio interface or by cellular interface or both), compute relative-speed data of the objects within the service spatial domain and integrate the computed relative-speed data into a centralized data map. Furthermore, having full visibility of the local domain, edge computing devices may determine local relative-speed data relevant for at least one user equipment, according to at least one V2X application (e.g., a safety application or Automated Driving application), the at least one user equipment being registered as subscriber to the service RES. The edge computing devices may provide the specific local relative-speed data to the user equipment, according to the at least one V2X application.

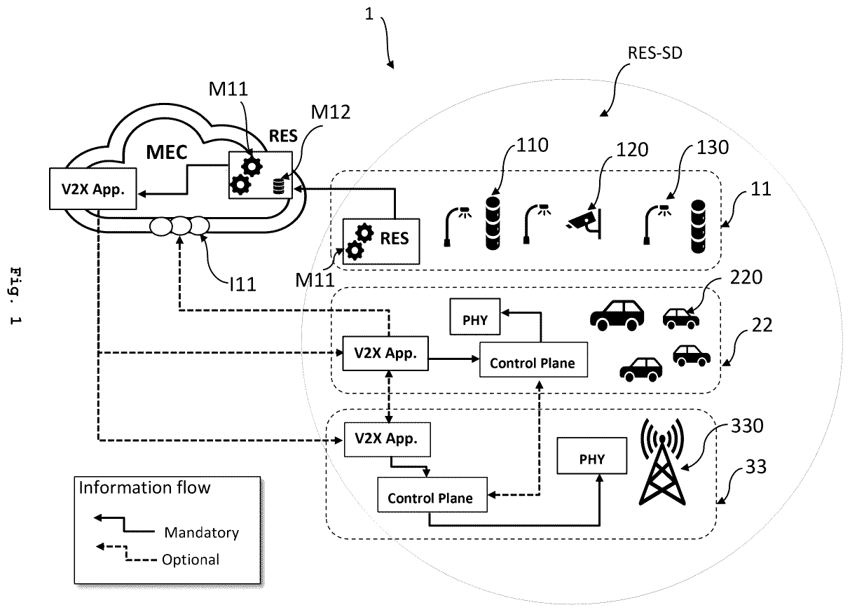

FIG. 1 illustrates an example of a Multi-Access Edge-Computing system 1 including devices and network entities operating in a multi-access wireless communication environment, able to provide specific local relative-speed data as a service, according to embodiments of the invention. A relative-speed service RES is provided by roadside units 11 equipped with sensorial means 110, 120, 130 covering a service local domain RES-SD. Service local domain RES-SD is the local area from where data are collected for the service and where data provided by the service are accessible in real-time. Sensorial means 110, 120, 130 deployed within the service spatial domain RES-SD may directly measure velocity data of objects 22 (including vehicles and non-vehicles such as pedestrians, cyclists, personal mobility devices, delivery robots, etc., within the service spatial domain), to be collected and processed by roadside units 11 that may operate as nodes for a multitude of wireless communication networks 330 (e.g., 4G, 5G, 6G) within a wireless communication environment 33 employed to interwork for the purpose of the service and to make also possible communication between user equipment based on a plurality of V2X applications. Some of the objects 22 are provided with user equipment (not illustrated nor referenced as such) and subscribed as users 220 of the relative-speed service RES. Communication between users 220 and wireless communication network is made via a plurality of V2X applications, either able to communicate directly (e.g., V2V applications), or by means of control plane of network entities and user equipment devices, respectively. Transmission and reception of data are processed at physical layer PHY.

In this example, service local domain RES-SD may be an intersection or a highway portion provided with infrastructure belonging to Intelligent Transport Systems (ITS). A typical example of such infrastructure are stationary roadside units (e.g., beacons, traffic poles) or mobile units (e.g., trucks, mobile boxes, aerials or drones-not illustrated) equipped with their own sensors (e.g., radar sensors). The range of sensorial means used to collect velocity data is not limited to radar techniques, such as Doppler radars, they may also include camera, lidar, ultrasonic sensors, etc. Some of roadside units 11 may be embodied by base stations, mobile network nodes, roadside access points (RAPs), nodes or servers provided with one or more edge devices M11 (meaning devices comprising at least one wireless communication interface 111, a memory M12, and one or more processors communicatively coupled with the communication interface and memory, the one or more processors configured to perform processor-executable instructions) with edge computing functions, able to collect the velocity data, process them and store the processed data. Some of them may act as intermediary nodes that may send collected velocity data to an edge-computing cloud network, where the data processing is enhanced by an edge-computing cloud service.

All in all, such edge units, devices and networks may be able to interwork as entities of a distributed edge environment.

However, directly measuring velocity data ensures a mandatory flow of information for the service, whereas optional flows of information (illustrated with dashed line in FIG. 1) are ensured by collecting similar information from users feeding the service (e.g., vehicles equipped with sensors able to measure velocity data of other vehicles or non-vehicles in direct vicinity), or velocity data relayed via networks (e.g., velocity data relayed by a local radio network).

As shown in FIG. 1, the main source of information for the relative-speed service RES is direct measurements of velocity data by the sensors 110, 120, 130 deployed within the service domain RES-SD (as stationary or mobile units), and feeding the service RES. A secondary source of information is similar data (velocities, headings, locations of objects and other vehicles in vicinity) collected through their own sensorial means (radar, camera, lidar, ultrasonic sensors and so on) by user 220 subscribed as users of the service, found within the local service domain RES-SD and feeding the relative-speed service RES. The secondary source of information may be used to validate the information received by direct measurements or may be fusioned with the rest of the data at the level of edge-computing device M11, according to a predetermined model.

In case the user is a mobile user equipment-V2X application pair able to inform in advance about a planned route of the user any of the multi-access edge-computing devices providing the relative-speed service along the planned route, it is possible that this information to be passed in advance to other multi-access edge-computing devices providing the service along the planned route towards a planned destination, so that the service local domain served by respective multi-access edge-computing devices to be known at application layer. Further on, a local multi-access edge computing device may determine which other multi-access edge computing devices are providing the service along the planned route. At least one of multi-access edge computing devices may analyze the planned route, provided by the user, for determining and providing alternative routes with continuously provided relative speed service, until the indicated destination is reached. Furthermore, the user equipment-V2X application pair may indicate a change in the planned destination, upon which the respective multi-access computing device providing the local relative speed service will provide updated alternative route proposals accordingly. Thus, a mobile user equipment-V2X application pair is enabled to continuously use and benefit from the provided relative speed service along the route.

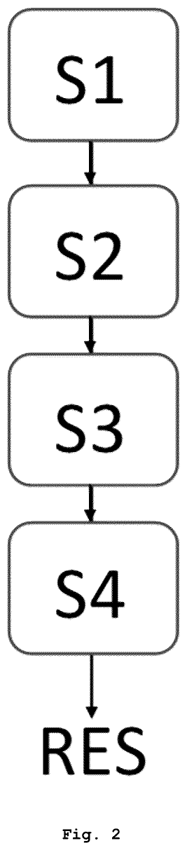

FIG. 2 illustrates the method of providing relative-speed data as a service RES, performed by multi-access edge computing devices M11 in a wireless communication environment 33. A first step S1 is collecting velocity data of objects 22 within a service spatial domain RES-SD of an edge-computing device M11, by velocity data meaning time-stamped velocities, headings, and locations of the respective objects. Referring to FIG. 1 again, collecting velocity-related data of objects 22 found within service spatial domain RES-SD comprises collecting velocity data measured directly by sensors 110, 120, 130 deployed within the service spatial domain RES-SD of the edge-computing device M11. Collected velocity data are the input data for the second step S2: computing relative-speed data of the objects 22 within service spatial data RES-SD and integrating the computed relative-speed data into a centralized data map. The centralized map is maintained in a memory M12 of edge-computing device M11. Having full visibility of relative speeds of all the objects within the service spatial domain RES-SD, edge-computing devices M11 may be able to perform a third step, namely S3 determining which local relative-speed data are relevant to at least one user 220 registered as subscriber to the relative-speed service RES, equipped with at least one user equipment (not figured), according to at least one V2X application from a plurality of V2X applications. The determined local relative-speed data are provided as output to the at least one user 220, according to the at least one V2X application (fourth step S4).

The centralized relative-speed data map is maintained in at least one edge computing device M11. The centralized map includes continuously updated relative-speed data of all the objects within the service spatial domain of the at least one edge-computing device. Updating continuously the computed relative-speed data requires a periodicity almost similar with the measurement cycle of the sensors involved, e.g., milliseconds or even microseconds. The reason for such quite high periodicity is that collecting, computing and storing the computed data altogether has to be performed within similar time threshold in order to meet latency level for other services using these data.

Computing relative-speed data in respect to the objects within the service spatial domain, and integrating the computed relative-speed data into a centralized data map, for example a 2D or 3D matrix comprising velocity vectors, is the main task of edge-computing devices. The reason for centralizing such data is to have full visibility of the service local domain in terms of relative speeds at a given time. In other words, instead of creating an ego-centric “environmental model” of external objects as perceived by each vehicle through its own sensors measurements, with limited capabilities and visibility, now edge-computing means are responsible for creating a full visibility picture or map of objects, perceived in terms of relative speed. In this respect, the centralized map is unique per se.

Nevertheless, vehicles attempting to traverse an intersection may only find data relevant within a certain proximity to the intersection. Similarly, for vehicles participating in cooperative driving, only vehicles affected by a maneuver may find the data relevant. This is of a particular relevance for vehicles able to receive Basic Safety messages (BSM) or Cooperative Awareness messages (CAM). Therefore, it would be another task for edge-computing devices to analyze the full map and to determine when a particular situation, scenario or use case occurs, which are the objects of interest participating to that particular situation, scenario or use case, and to extract the relevant data for them. From this point of view, the unique centralized map becomes unique for each user equipment. Following paragraphs are intended to make a better understanding of what it is meant by particular situation, scenario or use case.

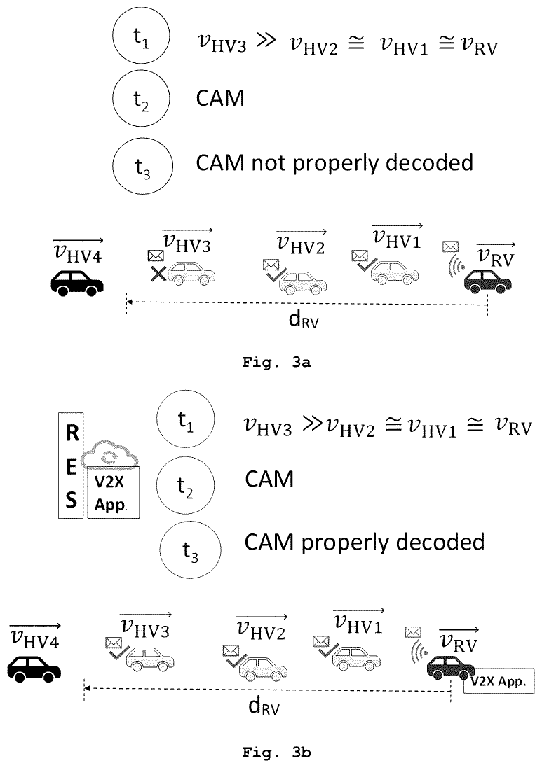

Referring now to FIGS. 3a and 3b, a generic use case is illustrated, namely Emergency Brake Warning (as described by 5GAA's document “C-V2X Use Cases and Service Level Requirements Volume I”, Sub-section 6.1.3 Emergency Brake Warning) in two scenarios: without relative-speed service (FIG. 2a) and with relative speed service (FIG. 2b). According to the mentioned specifications, the definition of Emergency Brake Warning is “providing drivers with timely alerts of nearby emergency breaking events to improve the awareness and reaction time needed to handle unexpected situations”. Road environment is either urban, rural or highway, within a range of 360m; the service level latency is 120 ms.

The scenario without relative-speed service is illustrated at three consecutive moments of time, t1, t2, t3. Objects are five vehicles, a remote vehicle RV, a first host vehicle HV1, a second host vehicle HV2, a third host vehicle HV3 and a fourth host vehicle HV4, moving in the same direction, one behind another, the remote vehicle being the one prone to apply emergency braking. All actors (remote and host vehicles) are equipped with user equipment (e.g., V2X device with at least one transceiver/receiver per vehicle) able to send and receive cooperative awareness messages (CAM) via V2V communication within a communication range d_{RV}; everybody within this range must be reliably notified. However, according to this scenario, at first moment t1, the third host vehicle HV3 has a speed significantly higher than the rest of the speeds, while the speeds of remote vehicle RV, first host vehicle HV1 and second host vehicle HV2 are similar. Fourth host vehicle HV4 does not require to receive Emergency Brake notifications from remote vehicle RV, since it is outside the communication range d_{RV}.

At second moment t2, remote vehicle RV may, using its own capabilities (e.g., radar sensors), determine that first and second host vehicles HV1 and HV2 are approaching. At third moment t3, when respective relative-speed data are transmitted via V2V communication as cooperative awareness messages (CAM), first and second host vehicle HV2 and HV3 may properly receive and decode such messages. At same time, though, due to the higher speed of approaching third host vehicle HV3 and due to the lack of Doppler shift compensation, the message containing respective relative speed data may not be properly received/decoded by third host vehicle HV3, even though this vehicle is moving within relevant communication range.

FIG. 3b presents a scenario that introduces a relative-speed service RES covering the same road environment as mentioned before, namely a portion of rural, urban or highway road; the assumptions related to speeds of remote vehicle RV and host vehicles HV1, HV2, HH3 and HV4 are the same, namely the speed of the third host vehicle HV3 is higher than the speeds of the host vehicles HV1 and HV2 (which speeds are similar). One difference is that, in this case, the remote vehicle is a user of the relative-speed service, possessing a user equipment having assigned a safety function (for example, a vehicle driving support system equipped with a V2X device, able to send a cooperative awareness message concerning an imminent braking—or Emergency Brake Warning). The difference is that also infrastructure deployed alongside the respective road portion plays a role of collecting data about vehicles within the considered road portion. The infrastructure may be, for example, roadside units with Doppler radar sensors. Such roadside units may also comprise edge-computing devices able to process the collected data “on the spot”, according to a V2X application, or may transmit the collected data further on to an edge cloud computing application to be processed—provided an enhanced latency is obtained. The processed data comprise relative speeds of all the vehicles (RV, HV1-HV4), centralized in a full-visibility map. Furthermore, relevant objects for the scenario “Emergency Brake Warning” are identified from centralized map, namely the remote vehicle RV and the first, second and third host vehicles, HV1, HV2, HV3 (according to the same or another, second V2X application). Relevant relative speed data are determined (according to the same or another, third V2X application). Since all vehicles of interest are heading in the same direction, relative speed data of relevance for the four vehicles are only scalar values, and more specifically, for the safety function concerned, only the maximum value of all three scalar values is relevant from the point of view of remote vehicle RV—the user of the RES service. Thus, the relevant data for the case at hand is the relative speed between remote vehicle and the third vehicle, expressed as scalar value, and this data may be used as reference for Doppler shift compensation, in order to adjust properly the transmission parameters between remote vehicle RV and third host vehicle HV3. Also, in order to meet latency level of Emergency Brake Warning (under 120 ms), the collecting, processing and determining of relevant data should be made within a threshold of tens of miliseconds—parameter configurable at the embedded user equipment by means of V2X application or on demand.

In other words, according to embodiments of the invention, there is a unique relative speed map per user equipment, but several sub-sets of relative speed data delivered at different times or with different periodicities, depending on the needs, requirements or constraints of different V2X applications paired with that particular user equipment.

Since there are a plurality of V2X-applications involved, it is possible that different edge-computing devices to concur to the final result (provided some computing operations do not depend on previous processed data, and may be performed in parallel). Thus, instead of collecting speed data by its own sensors and processing relative speed data by its own computing resources, less alone that such tasks wouldn't be feasible by mobile devices (e.g., smartphones), remote vehicle RV receives only the minimum amount of information of relative-speed data, adapted to the user equipment used and to the application itself.

Additionally, a V2X-application knows the communication range, and may also determine which vehicles are not of interest for that application; in this case, for example, information about the fourth host vehicle HV4 is not transmitted. Another option is to transmit data to remote vehicle RV periodically or on-demand.

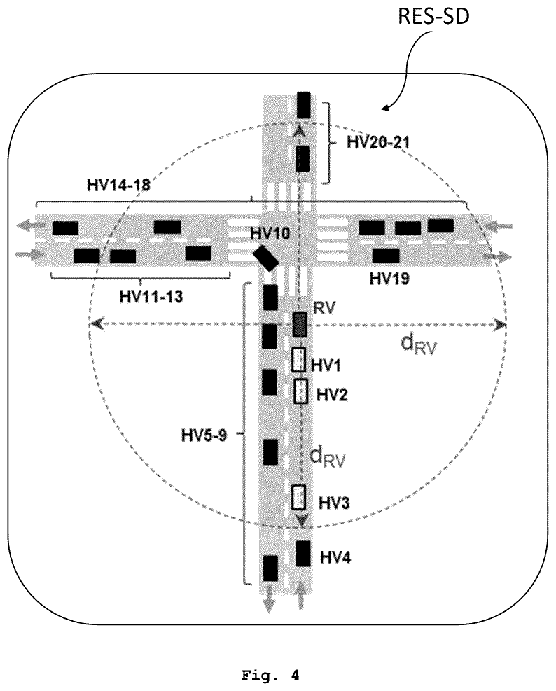

FIG. 4 illustrates an embodiment of providing the relative-speed service (RES), according to embodiments of the invention, where the service domain is an intersection, and providing specific relative-speed data within a local spatial domain RES-SD. In fact, it is depicted a situation quasi-similar to the one illustrated by FIG. 3b but introducing the intersection with a larger service spatial domain RES-SD, and much more objects involved (21 instead of just five). Remote vehicle RV, user of the service, has a user equipment with communication range d_{RV} running a plurality of V2X applications concerning generic or specific functions (Emergency Brake warning being one of them—therefore the case is described from the perspective of the remote vehicle user equipment associated with V2X application concerning Emergency Brake warning); the other 20 vehicles with various velocities (speeds and headings) are found in or out the communication range, and as such may be considered or not as of relevance for the purpose of at least one of the mentioned V2X application. In this embodiment, remote vehicle RV is the first vehicle approaching the intersection, followed in a row by a first, a second and a third host vehicle HV1, HV2 and HV3; a fourth host vehicle HV4, although also following behind the third host vehicle, is not in the communication range, and as such, its velocity data are not of relevance (in the time illustrated by this figure) for any communication application. Same applies for other host vehicles (HV5, HV14, HV21), not found in the communication range d_{RV}.

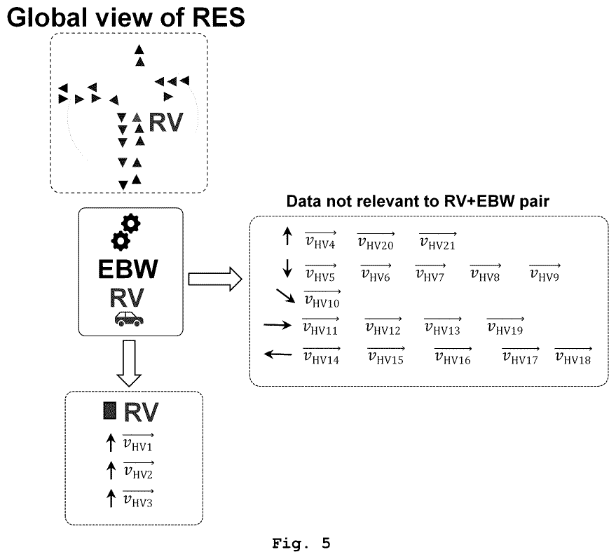

FIG. 5 illustrates the case of FIG. 4 as seen in a virtual domain, to have a better overview of the centralized map of data used for relative-speed service RES. According to this representation, from the point of view of RV user equipment, associated with a V2X application concerning Emergency Breaking warning, a plurality of vehicles is not of interest for the mentioned scenario, therefore their velocity data are not considered relevant, relative speeds are not computed and not sent to the remote vehicle user equipment.

Therefore, once the global, centralized map is completed with all the velocity data of the vehicles within the service spatial domain (global view of RES-SD), it is visible that a situation concerning Emergency Brake Warning involves only the remote vehicle RV and the following three host vehicle HV1, HV2 and HV3; the warning would be initiated by remote vehicle RV, targeting the vehicles located behind. Therefore, to the remote vehicle RV are sent only relative-speed data concerning the relevant vehicles, namely first, second and third host vehicles HV1, HV2, HV3 (as already described before). Since the approaching to the intersection center would mean a more acute need for information concerning the Emergency Brake warning, it would be indicated not to get the data on-demand (meaning an external action), but automatically and periodically, as much as the remote vehicle RV gets closer to the intersection center.

Emblematic implementations for safety may include other mechanisms such as, for example: Vulnerable Road User Safety Message, as described by SAE document “Minimum Performance Requirements” J2945/9, issued in March 2017; Collective Perception Message (CPM), as described by ETSI technical report TR 103 562 V2.1.1 (2019-12) “Intelligent Transport Systems (ITS); Vehicular Communications; Basic Set of Applications; Analysis of the Collective Perception Service (CPS); Release 2”; Vulnerable Road User Awareness Message (VAM), as described by ETSI technical specification TS 103300-3V2.1.2 (2021-04) “Intelligent Transport Systems (ITS); Vulnerable Road Users (VRU) awareness; Part 3: Specification of VRU awareness basic service; Release 2”. Other possible implementations may be useful for infotainment (concerning perception-aware multiple scalable video streaming) and sensor sharing.

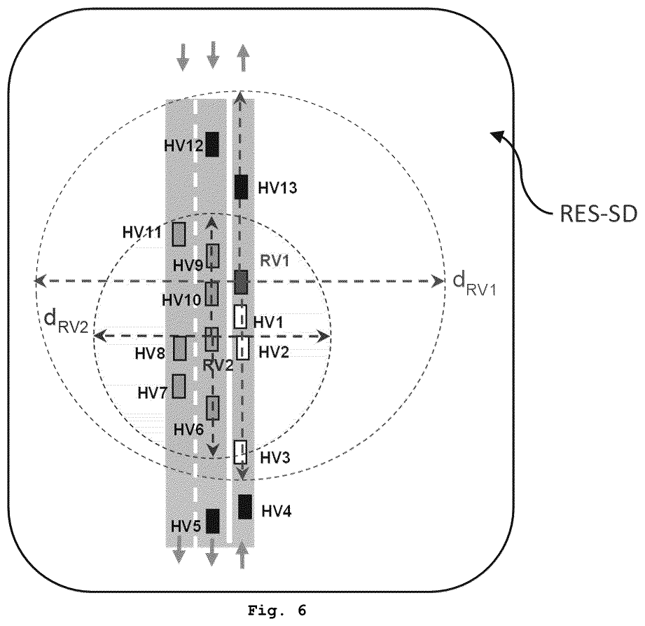

FIG. 6 illustrates another use case for providing a relative speed service to two users with different communication ranges, as to be better understood the user equipment-V2X application pair centric nature of the invention. In this case, within spatial domain RES-SD served by the relative speed service several vehicles are found at a given time, a first remote vehicle RV1, user of the service RES, a second remote vehicle RV2, also user of the service RES, as well as host vehicles HV1, HV2, . . . . HV13 moving in the same direction or in opposite direction against the two remote vehicles RV1, RV2—in total, 15 objects. Each of the remote vehicles RV1, RV2 has its own communication range, d_{RV1} and d_{RV2} respectively, the two communication ranges being different one from another (parameter depending on the user equipment employed by each respective vehicle). A first application V2X-App1 runs on the user equipment of first remote vehicle RV1; a second application V2X-App2 runs on the user equipment of the second remote vehicle RV2. In this case, for the pair user equipment RV1-V2X-App1, the relevant vehicles are the ones within communication range d_{RV1}, following first remote vehicle RV1 and moving in the same direction—therefore, host vehicles HV1, HV2, HV3, and a sub-set of specific relative speed data (RSD1, not illustrated) concerning only those three vehicles is provided periodically, e.g., every 200 ms. For the other pair user equipment RV2—V2X-App2, the relevant vehicles are the ones within communication range d_{RV2}, most precisely host vehicles HV1-HV3 and HV6-HV11, plus first remote vehicle RV1, thus another specific sub-set of data (RSD2, not illustrated) is provided on demand. Moreover, the edge-computing devices allocated to RES-SD maintain and continuously update a full relative speed map for all 15 objects, meaning 105 pairs of different relative speed values

$$( corresponding to n \times \frac{n - 1}{2} relative speed values for n objects ) .$$

105 pairs, the first sub-set of data RSD1, required by RV1, contains only 3 pairs, and even more specific, 3 values, which makes for 3% data from the centralized map. Again, the second sub-set of data required by RV2 contains only relative speeds between second remote vehicle RV2 and the rest of 10 objects, i.e., 10 pairs (10 values) are required by RV2-V2X App2 (10% of data from the full set).

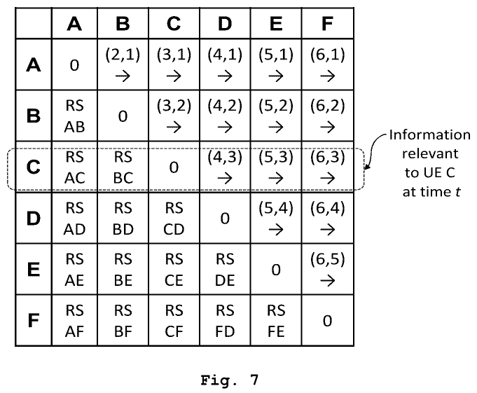

FIG. 7 presents an embodiment of a time-stamped relative-speed data map comprising 2D data of relative-speed for a generic application, employing several users (six, referred as A to F). More precisely, the map comprises relative speeds (RS) of pairs of users AB, AC, . . . . FE, as well as respective directions. Useful for the purpose of the relative-speed service RES, from the point of view of user C (third horizontal row), at a given moment t—as enclosed by the dashed line illustrated FIG. 6. These are the only relative-speed data that are sent to the user C, in a format suitable for the specific user equipment—V2X application. In other words, instead of making all relative-speed data available to all users, only partial data of relevance to a given user are provided, according to the user equipment and the V2X application concerned.

However, while certain embodiments of the present invention have been described in detail, those familiar with the art to which this invention relates will recognize various alternative designs and embodiments for practicing the invention as defined by the following claims.

### LIST OF REFERENCE NUMBERS

1—Multi-Access Edge-Computing System
11—Roadside units
110, 120, 130—Sensors
22—Objects/vehicles/non-vehicles
220—User of relative speed service
33—Wireless communication environment
330—Wireless communication network
RV, RV1, RV2—Remote Vehicles
HV1 . . . HV21—Host Vehicles
d_{RV}—Communication range of the remote vehicle
A-F—Users of the relative-speed service RES
I11—Communication interfaces
M11—Multi-access computing devices
M12—Memory
RES—Relative-speed service
RSD1, RSD2—sub-sets of relative speed data
PHY—Physical layer
V2X App-Vehicle-to-Everything Application

1. A method performed by multi-access edge computing devices for providing relative speed data as a service in a wireless communication environment, comprising:
collecting, by at least one multi-access edge computing device, velocity data of objects within a service spatial domain of the at least one edge computing device, by velocity data meaning time-stamped velocities, headings, locations of the respective objects,
computing, by the at least one edge computing device, relative speed data of the objects within the service spatial domain, and integrating the computed relative speed data into a centralized data map,
determining, by the at least one edge computing device according to at least one V2X application from the plurality of V2X applications, which local relative speed data are relevant to at least one user registered as subscriber to the relative speed service,
providing, by the at least one edge computing device according to the at least one V2X application from the plurality of V2X applications, the determined local relative speed data to the at least one user equipment according to the at least one V2X application, either periodically or on demand.

2. The method of claim 1, wherein collecting velocity-related data of objects moving within a service spatial domain comprises:
collecting velocity data measured directly by sensors deployed within the service spatial domain of at least one multi-access edge computing device.

3. The method of claim 1, wherein the centralized relative speed data map is maintained in at least one edge computing device and includes continuously updated relative speed data of all the objects within the service spatial domain of the at least one edge computing device.

4. The method of claim 1, wherein the user is a user equipment and determining, by the at least one edge computing device according to at least one V2X application from the plurality of V2X applications, which local relative speed data are relevant to at least one user registered as subscriber to the relative speed service, comprises: identifying which are the objects of interest for a situation, use case or scenario specified by the at least one V2X application, by analyzing respective objects' locations, velocities and relative speeds in respect to each other at a given time.

5. The method of claim 1, wherein providing, by the at least one edge computing device according to the at least one V2X application from the plurality of V2X applications, the determined local relative speed data to the at least one user equipment according to the at least one V2X application further means making data available within a service time threshold, configurable according to the at least one V2X application and the user equipment, or on demand.

6. The method of claim 1, wherein providing, by the at least one edge computing device according to the at least one V2X application from the plurality of V2X applications, the determined local relative speed data to the at least one user equipment according to the at least one V2X application, further means making the determined data available in a format suitable for the user equipment according to the at least one V2X application.

7. The method of claim 1, wherein the user is a mobile user equipment-V2X application pair able to provide information regarding a planned route of the user towards a planned destination, the method further comprising receiving by at least one multi-access device the information regarding the planned route and determining which other multi-access edge computing devices are providing the service along the planned route.

8. The method of claim 7, further comprising providing by at least one multi-access device, information to the user regarding alternative routes with continuously provided relative speed service, until the planned destination is reached.

9. A multi-access edge computing device associated with a relative speed service, comprising at least one wireless communication interface, a memory, and one or more processors communicatively coupled with the communication interface and memory and configured with processor-executable instructions to perform operations comprising:
collecting, by at least one multi-access edge computing device, velocity data of objects within a service spatial domain of the at least one edge computing device, by objects,
computing, by the at least one edge computing device, relative speed data of the objects within the service spatial domain, and integrating the computed relative speed data into a centralized data map,
determining, by the at least one edge computing device according to at least one V2X application from the plurality of V2X applications, which local relative speed data are relevant to at least one user registered as subscriber to the relative speed service,
providing, by the at least one edge computing device according to the at least one V2X application from the plurality of V2X applications, the determined local relative speed data to the at least one user equipment according to the at least one V2X application, either periodically or on demand.

10. The multi-access edge computing device according to claim 9, wherein the edge-computing device is base station, mobile network node, roadside unit, roadside access point, node or server with edge computing functions, situated in geographic proximity to the relative speed service spatial domain.

11. A non-transitory processor-readable medium having stored thereon processor-executable instructions configured to cause a processor of an edge computing device to perform operations comprising:
collecting, by at least one multi-access edge computing device, velocity data of objects within a service spatial domain of the at least one edge computing device, by objects,
computing, by the at least one edge computing device, relative speed data of the objects within the service spatial domain, and integrating the computed relative speed data into a centralized data map,
determining, by the at least one edge computing device according to at least one V2X application from the plurality of V2X applications, which local relative speed data are relevant to at least one user registered as subscriber to the relative speed service,
providing, by the at least one edge computing device according to the at least one V2X application from the plurality of V2X applications, the determined local relative speed data to the at least one user equipment according to the at least one V2X application, either periodically or on demand.

12. A system for providing relative speed data as a service covering a service spatial domain, comprising:
sensors measuring velocity-related data of objects within the service spatial domain, by velocity-related data meaning time-stamped locations, headings, velocities of the respective objects,
user equipment able to communicate wirelessly via various communications interfaces, transmitting and receiving relative speed data requested by a plurality of V2X applications, and
at least one multi-access edge computing device configured to perform operations comprising:
collecting, by at least one multi-access edge computing device, velocity y data of objects within a service spatial domain of the at least one edge computing device, by objects,
computing, by the at least one edge computing device, relative speed data of the objects within the service spatial domain, and integrating the computed relative speed data into a centralized data map,
determining, by the at least one edge computing device according to at least one V2X application from the plurality of V2X applications, which local relative speed data are relevant to at least one user registered as subscriber to the relative speed service,
providing, by the at least one edge computing device according to the at least one V2X application from the plurality of V2X applications, the determined local relative speed data to the at least one user equipment according to the at least one V2X application, either periodically or on demand.

13. The system according to claim 12, wherein the sensors collecting velocity data are sensors placed on infrastructure deployed within the service spatial domain, e.g., radar, camera, lidar, ultrasonic sensors, belonging to road infrastructure.

14. The system according to claim 12, wherein the sensorial means belong to vehicles moving within the service spatial domain and feeding the relative speed service, including Unmanned Aerial Vehicles or drones carrying radar, camera, lidar or ultrasonic sensors.

15. The system according to claim 12, wherein the user equipment is a mobile device, wearable device, conventional or smart personal mobile phone, a car-mounted user equipment, and/or any user equipment embedded in mobile objects, such as drones, motorbikes, e-Bikes, delivery robots, personal mobility devices, wheelchairs, scooters.
